(19) United States
(12) Patent Application Publication
(10) Pub. No.: US 2015/0332323 A1
(43) Pub. Date: Nov. 19, 2015

(54) SERVER AND PROGRAM

(71) Applicant: Toshiba Tec Kabushiki Kaisha, Tokyo (JP)

(72) Inventor: Rintaro Nakane, Yokohama (JP)

(21) Appl. No.: 14/697,951

(22) Filed: Apr. 28, 2015

(30) Foreign Application Priority Data
May 19, 2014 (JP) 2014-103743

(51) Int. Cl. G06Q 30/02

(52) U.S. Cl. CPC G06Q 30/0256

(57) ABSTRACT

A server includes merchandise extraction means for extracting specific merchandise regarding which information is provided to a customer from a plurality of merchandise items on the basis of customer information which is registered in relation to the customer, first delivery means for delivering first content for the specific merchandise to a first electronic apparatus used by the customer, and second delivery means for delivering second content for the specific merchandise to a second electronic apparatus used by a store staff member. The first delivery means delivers the first content corresponding to the changed second content to the first electronic apparatus in response to a request for changing the second content from the second electronic apparatus. The second delivery means delivers the second content corresponding to the changed first content to the first electronic apparatus in response to a request for changing the first content from the first electronic apparatus.

### CROSS-REFERENCE TO RELATED APPLICATION

This application is based upon and claims the benefit of priority from Japanese Patent Application No. 2014-103743, filed May 19, 2014, the entire contents of which are incorporated herein by reference.

### FIELD

Exemplary embodiments described herein relate to a server providing content regarding merchandise, and a program.

### BACKGROUND

There are cases where a business negotiation room or the like for exclusive use of members is provided in a large store or the like. If a member uses a business negotiation room for exclusive use of members, the member can enter the room by being authenticated with a membership card or the like. The member can receive services such as drinks or introduction of merchandise using a printed catalog from outside customer staff or customer service staff in the business negotiation room.

If a printed catalog based on paper media is used, the member is unlikely to find favorite merchandise as the number of items of merchandise listed therein is large. In addition, if a customer designates merchandise from a printed catalog, a store staff is required to perform an input operation or the like on a dedicated terminal which is separately provided in order to perform a procedure for reservation or purchase of the merchandise.

Further, information listed in a printed catalog may be simply generated as electronic data and may be provided to customers via an electronic apparatus. However, in this case, a member is unlikely to find favorite merchandise only if the operability becomes better.

In the related art, a system is considered in which information such as purchase history of a plurality of customers is analyzed, merchandise corresponding to a customer type is specified, and information regarding the merchandise is provided to a customer terminal used by a customer and is also provided to a web server or a store terminal from an information providing device.

JP-A-2013-239160 is an example of the related art.

### DESCRIPTION OF THE DRAWINGS

FIG. 1 is a block diagram illustrating a configuration example in which a content providing system of the present exemplary embodiment is realized as a customer service system.

FIG. 2 is a diagram illustrating an example of a situation in which the customer service system is used.

FIG. 3 is a block diagram illustrating an example of a configuration of a customer information management system.

FIG. 4 is a block diagram illustrating an example of a configuration of a content delivery system.

FIG. 5 is a diagram illustrating an example of customer information included in a customer information database of the customer information management system.

FIG. 6 is a diagram illustrating an example of information included in a merchandise information database of the content delivery system.

FIG. 7 is a diagram illustrating an example of information included in an attribute cluster database.

FIG. 8 is a diagram illustrating an example of attribute-based merchandise information.

FIG. 9 is a diagram illustrating a flow of information which is transmitted and received between store staff and a customer in the customer service system.

FIG. 10 is a flowchart illustrating a process of allocating a reception device to a customer who visits a business negotiation room.

FIG. 11 is a flowchart illustrating a process of synchronizing content items displayed on a tablet terminal and a handy terminal with each other.

FIG. 12 is a diagram illustrating extraction of content for a customer, performed by the content delivery system.

FIG. 13 is a diagram illustrating a display example of content displayed on the tablet terminal.

FIG. 14 is a diagram illustrating a display example of content.

FIG. 15 is a diagram illustrating an example in which content synchronized with the tablet terminal is displayed on a staff terminal.

FIG. 16 is a diagram illustrating a display example of content displayed on the tablet terminal.

FIG. 17 is a diagram illustrating a display example of content.

FIG. 18 is a diagram illustrating a process of changing content on the basis of information which is input from the staff terminal.

FIG. 19 is a diagram illustrating extraction of content for a customer, performed by the content delivery system.

FIG. 20 is a diagram illustrating a process of changing content on the basis of information which is input from the tablet terminal.

FIG. 21 is a diagram illustrating extraction of content for a customer, performed by the content delivery system.

### DETAILED DESCRIPTION

As mentioned above, in the related art, the information is provided not only to the customer terminal but also to the web server or the store terminal from the information providing device, and thus the information can also be provided to a salesperson and the like.

However, in the system in which merchandise is specified according to a customer type, various information pieces obtained from a customer by a store staff member through conversation or the like between the store staff member and the customer during customer service, or the customer's needs at that time cannot be acquired as occasion demands. Therefore, new information obtained during customer service cannot be reflected in the customer terminal or the store terminal.

An object of the exemplary embodiments is to provide a server and a program capable of outputting newly added information through synchronization between an apparatus used by a customer and an apparatus used by a store staff member.

According to the present exemplary embodiment, a server includes merchandise extraction means for extracting specific merchandise regarding which information is provided to a customer from a plurality of merchandise items on the basis of customer information which is registered in relation to the customer, first delivery means for delivering first content for the specific merchandise to a first electronic apparatus used by the customer, and second delivery means for delivering second content for the specific merchandise to a second electronic apparatus used by a store staff member. The first delivery means delivers the first content corresponding to the changed second content to the first electronic apparatus in response to a request for changing the second content from the second electronic apparatus. The second delivery means delivers the second content corresponding to the changed first content to the first electronic apparatus in response to a request for changing the first content from the first electronic apparatus.

Hereinafter, the present exemplary embodiment will be described with reference to the drawings.

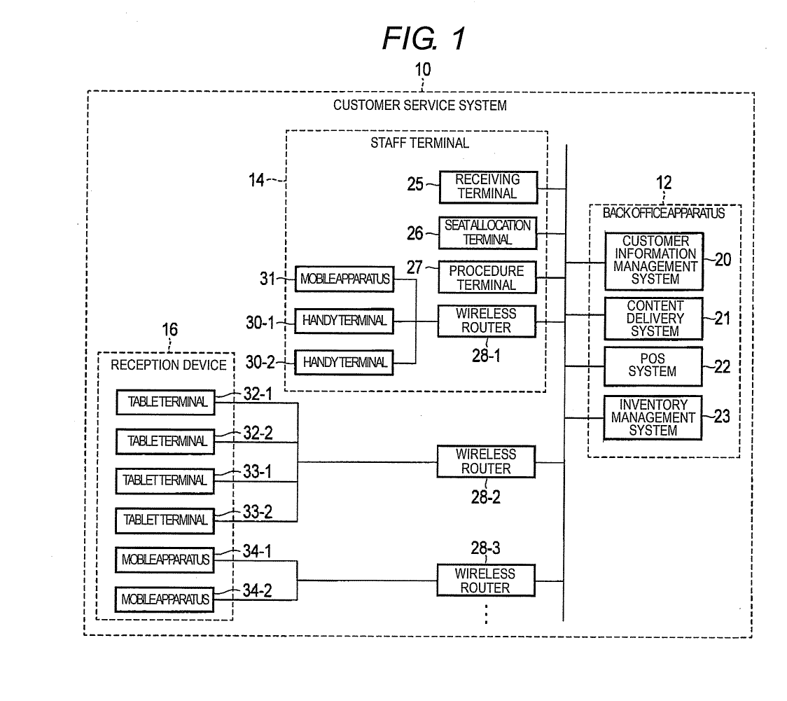

FIG. 1 is a block diagram illustrating a configuration example in which a content providing system of the present exemplary embodiment is realized as a customer service system 10. The customer service system 10 can provide information (content) regarding merchandise which is currently being sold in, for example, a store, to an electronic apparatus which is used by a customer or a store staff member. The customer service system 10 is provided in, for example, a business negotiation room for exclusive use for customers of a store, and is used when the store staff member provides customer service.

The customer service system 10 includes a back office apparatus 12 which performs management or control of the system, staff terminals 14 used by store staff members, and a reception device 16 which is mainly used by customers. The back office apparatus 12 includes, for example, a customer information management system 20, a content delivery system 21, a point of sales (POS) system 22, and an inventory management system 23.

The staff terminals 14 include, for example, a receiving terminal 25, a seat allocation terminal 26, and a procedure terminal 27. The customer information management system 20, the content delivery system 21, the point of sales (POS) system 22, the inventory management system 23, the receiving terminal 25, the seat allocation terminal 26, and the procedure terminal 27 are connected to each other via a network such as a wired local area network (LAN) and transmit and receive data to and from each other. In addition, the staff terminals 14 include, for example, a plurality of handy terminals 30 (30-1, 30-2, . . . ), and a mobile apparatus 31 which are connected to each other by using a network such as a wireless LAN via a wireless router 28-1.

The reception device 16 includes, for example, a plurality of table terminals 32 (32-1, 32-2, . . . ), a plurality of tablet terminals 33 (33-1, 33-2, . . . ), and a plurality of mobile apparatuses 34 (34-1, 34-2, . . . ) which are connected to each other by using a network such as a wireless LAN via wireless routers 28-2 and 28-3. The table terminals 32 are installed at fixed locations and may thus be connected to each other by using a wired LAN. The customer service system 10 treats personal information of customers and thus preferably employs a closed LAN which cannot be accessed from outside from the viewpoint of security.

The customer information management system 20 manages various information pieces regarding customers which are registered as members. The customer information management system 20 manages, for example, not only customer information regarding a customer registered when membership registration is performed, but also merchandise purchase history, customer visit history, person-in-charge information, and the like. The customer information management system 20 has functions of, for example, managing information (recommendation information) regarding specific merchandise, delivered from the content delivery system 21 to a customer, and managing view history for the recommendation information. The customer information management system 20 has functions of delivering information to the staff terminals 14, receiving information from the staff terminals 14, and transmitting and receiving information to and from the other systems 21 to 23.

The content delivery system 21 manages information (recommendation information) regarding merchandise, delivered to the staff terminals 14 or the reception device 16. The content delivery system 21 has a function of extracting merchandise which is recommended to a customer and delivering recommendation information (content) regarding the merchandise to the staff terminals 14 or the reception device 16 on the basis of customer information which is managed by the customer information management system 20 and of information or the like which is input from the staff terminals 14 or the reception device 16. The content delivery system 21 combines information pieces obtained by clustering customer attributes or merchandise attributes and extracts merchandise (merchandise cluster) recommended to a customer through cluster analysis. The content delivery system 21 has, for example, a designated customer attribute extraction function of extracting a customer attribute on the basis of customer information, a cluster management function of managing a customer attribute cluster and a merchandise attribute cluster, a function of managing merchandise information, a recommendation information inference function of extracting merchandise (merchandise cluster) for recommendation to a customer, and a supplementary information extraction function of extracting supplementary information which will be delivered to the staff terminals 14. The content delivery system 21 has functions of delivering information to the staff terminals 14, receiving information from the staff terminals 14, delivering information to the reception device 16, receiving information from the reception device 16, and transmitting and receiving information to and from the other systems 20, 22 and 23.

The POS system 22 manages sales of merchandise in the store. The POS system 22 has functions of performing a payment process, managing purchase history, transmitting and receiving information to and from the customer information management system 20 or the inventory management system 23, and the like. The inventory management system 23 has functions of managing a merchandise inventory in the store, transmitting and receiving information to and from the customer information management system 20 or the POS system 22, and the like, on the basis of the sales of merchandise managed by the POS system 22.

Each of the systems 20 to 23 may be realized by, for example, a single server (computer), or by a combination of a plurality of servers or other electronic apparatuses. Any of the systems 20 to 23 may be combined with each other so as to be realized as a single system.

The receiving terminal 25 is realized by, for example, a personal computer. The receiving terminal 25 includes a CPU, a network interface controller, storages (a memory, a solid state drive (SSD), an HD, and the like), an input device, a display device, and the like, and operates on the basis of programs such as an operating system (OS), middleware, and various applications. The receiving terminal 25 realizes a function for receiving business by the CPU executing a receiving business application program. The receiving terminal 25 has, for example, an authentication information input function for inputting authentication information specific to a customer, a customer information inquiry function of inquiring of the customer information management system 20 on the basis of authentication information, an additional information input function of a store staff member (person in charge of reception) inputting information (a purpose of visit, the number of accompanying persons, an attribute, and the like) regarding a customer, and a function of transmitting and receiving information to and from the customer information management system 20 or the staff terminals 14. The authentication information input via the receiving terminal 25 includes, for example, a member ID recorded on a membership card owned by a customer, information extracted from an image of a face of the customer, customer biometrics information (a fingerprint, a voiceprint, an iris, a vein pattern, and the like), a personal identification number, and a password.

The seat allocation terminal 26 is realized by, for example, a personal computer. The seat allocation terminal 26 includes a CPU, a network interface controller, storages (a memory, an SSD, an HD, and the like), an input device, a display device, and the like, and operates on the basis of programs such as an OS, middleware, and various applications. The seat allocation terminal 26 realizes a function for seat allocation business by the CPU executing a seat allocation business application. The seat allocation terminal 26 has, for example, a function of allocating the tablet terminals 33 and the table terminals 32 to customers, and a function of transmitting and receiving information to and from the customer information management system 20 or the staff terminals 14.

The procedure terminal 27 is realized by, for example, a personal computer. The procedure terminal 27 includes a CPU, a network interface controller, storages (a memory, an SSD, an HD, and the like), an input device, a display device, and the like, and operates on the basis of programs such as an OS, middleware, and various applications. The procedure terminal 27 realizes a function for reservation or purchase of merchandise by the CPU executing various functions providing applications. The procedure terminal 27 has, for example, a function of transmitting and receiving information to and from the table terminals 32 or the tablet terminals 33, transmitting and receiving information to and from the content delivery system 21, a merchandise information search function, a merchandise reservation purchase procedure function, a function of transmitting and receiving to and from the customer information management system 20, and a function of transmitting and receiving to and from other apparatuses including the POS system 22 and the inventory management system 23. The procedure terminal 27 has a function of printing a slip or the like if a printer is connected thereto, and has a scanner function of reading an image of a document or the like if a scanner is connected thereto.

The handy terminals 30 have a configuration equivalent to, for example, that of a personal computer. Each of the handy terminals 30 includes a CPU, a network interface controller, a near field wireless communication unit, storages (a memory, an SSD, an HD, and the like), an input device (including a touch panel), a display device, and the like, and operates on the basis of programs such as an OS, middleware, and various applications. Each of the handy terminals 30 further includes a card reader, a barcode reader, a camera, and the like. The handy terminals 30 operate on the basis of programs such as an OS, middleware, and various applications. The handy terminals 30 realize a function for performing business negotiation or the like with a customer by the CPU executing various functions providing applications. The handy terminals 30 have, for example, a function of transmitting and receiving information to and from the table terminals 32 or the tablet terminals 33 by using near field wireless communication, a function of transmitting and receiving information to and from the content delivery system 21, a merchandise information search function, and a function of transmitting and receiving to and from other apparatuses including the customer information management system 20, the POS system 22, and the inventory management system 23. In addition, the handy terminals 30 have a function of transmitting and receiving information to and from the staff terminals 14 by using near field wireless communication or a network. Each of the handy terminals 30 determines identification information specific to a customer (or the table terminal 32 or the tablet terminal 33 used by the user) by using data read from a membership card with the card reader or a one-dimensional or two-dimensional barcode read with the barcode reader, or by performing a recognition process on a two-dimensional barcode or an image captured by a camera. The handy terminals 30 may display information synchronized with recommendation information (content) displayed on the table terminals 32 or the tablet terminals 33 used by customers via the customer information management system 20 and the content delivery system 21 on the basis of the identification information.

The mobile apparatus 31 is realized by, for example, a tablet-type personal computer or a smartphone. The mobile apparatus 31 can realize the same function as the function of the handy terminals 30 by executing an application for causing the mobile apparatus 31 to function as the staff terminals 14.

The table terminals 32 have a configuration equivalent to, for example, that of a personal computer. Each of the table terminals 32 includes a CPU, a network interface controller, a near field wireless communication unit, storages (a memory, an SSD, an HD, and the like), an input device (including a touch panel), a display device, a camera, a microphone, and the like, and operates on the basis of programs such as an OS, middleware, and various applications. As the display devices of the table terminals 32, display devices with relatively large sizes are used so that display surfaces thereof can be used as table tops. Each of the table terminals 32 realizes a function for performing business negotiation with a store staff member by the CPU executing a content viewing application or an operation application. The table terminals 32 have, for example, a function of transmitting and receiving information to and from the staff terminals 14 by using near field wireless communication, a function of transmitting and receiving information to and from the customer information management system 20 or the content delivery system 21, a function (designation of favorite merchandise, a request for checking merchandise, reservation and purchase of merchandise, or inputting of a content keyword) of viewing recommendation information (content) received from the content delivery system 21, a function of viewing customer information or the like, and a function of transmitting and receiving information to and from the tablet terminals 33. The table terminals 32 may input information for narrowing down recommendation information (content) received from the content delivery system 21 by performing a recognition process of a two-dimensional barcode or an image captured by the camera.

Each of the tablet terminals 33 is realized by, for example, a tablet type personal computer. Each of the tablet terminals 33 includes a CPU, a network interface controller, a near field wireless communication unit, storages (a memory, an SSD, an HD, and the like), an input device (including a touch panel), a display device, a camera, a microphone, and the like, and operates on the basis of programs such as an OS, middleware, and various applications. Each of the tablet terminals 33 realizes a function for performing business negotiation with a store staff member by the CPU executing a content viewing application or an operation application. The tablet terminals 33 have, for example, a function of transmitting and receiving information to and from the staff terminals 14 by using near field wireless communication, a function of transmitting and receiving information to and from the customer information management system 20 or the content delivery system 21, a function (designation of favorite merchandise, a request for checking merchandise, reservation and purchase of merchandise, or inputting of a content keyword) of viewing recommendation information (content) received from the content delivery system 21, a function of viewing customer information or the like, and a function of transmitting and receiving information to and from the table terminals 32. The tablet terminals 33 may input information for narrowing down recommendation information (content) received from the content delivery system 21 by performing a recognition process of a two-dimensional barcode or an image captured by the camera.

Each of the mobile apparatuses 34 is realized by, for example, a tablet type personal computer or a smartphone. The mobile apparatuses 34 can realize the same function as the function of the table terminals 32 or the tablet terminals 33 by executing an application for causing the mobile apparatuses 34 to function as the reception device 16.

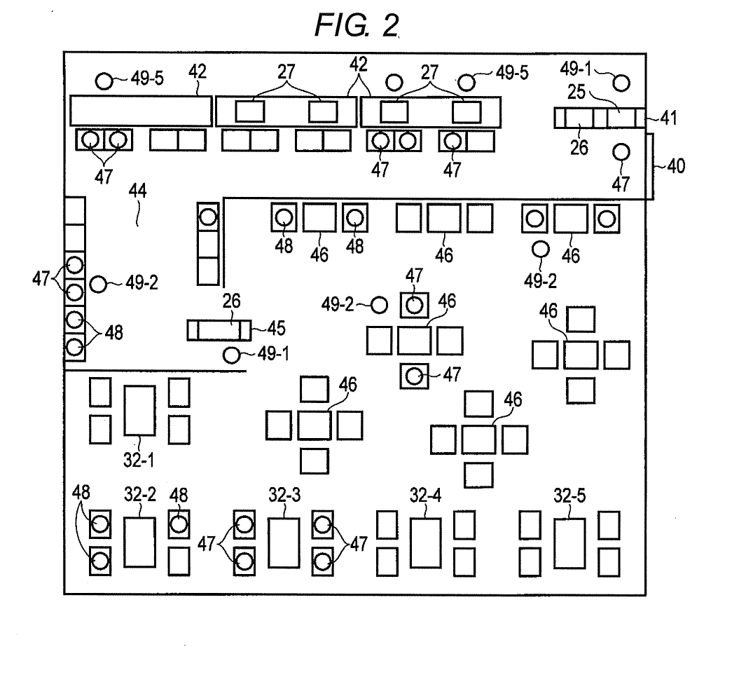

FIG. 2 is a diagram illustrating an example of a situation in which the customer service system 10 of the present exemplary embodiment is used. FIG. 2 illustrates an example in which the customer service system 10 is used in a business negotiation room for a customer (member) provided in the store, for example.

For example, the receiving terminal 25 and the seat allocation terminal 26 are disposed in a reception counter 41 provided near an entrance 40 of the business negotiation room. The receiving terminal 25 and the seat allocation terminal 26 disposed in the reception counter 41 are operated by a person in charge of reception 49-1 who is a store staff member. The person in charge of reception 49-1 operates the receiving terminal 25 so as to confirm membership registration of a customer 47 coming into the room on the basis of, for example, a membership card or to confirm a purpose of visit, and inputs necessary information. The person in charge of reception 49-1 operates the seat allocation terminal 26 so as to allocate the tablet terminal 33 or the table terminal 32 to the customer 47, or to allocate table seats 46 other than the table terminal 32 thereto. Customers 48 to which the tablet terminals 33 are lent can receive delivery of content for the customers through the tablet terminals 33.

A reservation consultation counter 42 is provided around the reception counter 41. The plurality of procedure terminals 27 are disposed in the reservation consultation counter 42. The procedure terminal 27 is operated by a person in charge of procedure 49-5 or a person in charge of customer service 49-2 who is a store staff member.

A waiting space 44 is provided in front of the business negotiation space. Seats for customers who are waiting for seats of the business negotiation space to become unoccupied are provided in the waiting space 44. The customer 48 to which the tablet terminal 33 is lent can also perform business negotiation by using the tablet terminals 33 with the person in charge of customer service 49-2 while waiting in the waiting space 44. The waiting space 44 is provided with a reception counter 45 in which the seat allocation terminal 26 is disposed.

For example, a plurality of table seats 46 and the plurality of table terminals 32 (32-1, . . . , and 32-5) are provided in the business negotiation space. The customer 47 to which the tablet terminal 33 is not lent is allocated the table terminal 32. The customer 47 can receive customer service from the person in charge of customer service 49-2 while viewing content displayed on the table terminal 32. The customer 48 to which the tablet terminal 33 is allocated can receive customer service from the person in charge of customer service 49-2 at both of the table seat 46 or the table terminal 32. The same content or different content items may be delivered from the content delivery system 21 to the tablet terminal 33 and the table terminal 32 used by the customer 48. For example, specific merchandise information or a plurality of merchandise images which are hard to display on a single screen in the tablet terminal 33 can be displayed by using a large screen of the table terminal 32.

The handy terminal 30 (or the mobile apparatus 31) carried by the person in charge of customer service 49-2 reads identification information specific to a customer (or the table terminal 32 or the tablet terminal 33 used by the customer), and notifies the content delivery system 21 (or the customer information management system 20) of the information, thereby displaying information synchronized with recommendation information (content) displayed on the tablet terminal 33 (and the table terminal 32) used by the customer. Here, the handy terminal 30 and the tablet terminal 33 (the table terminal 32) may receive different information pieces regarding the same merchandise from the content delivery system 21 and display different content items. For example, supplementary information or the like for explaining details of merchandise to the customers 47 and 48 may be displayed on the handy terminal 30 used by the person in charge of customer service 49-2.

There is a person in charge of outside customers or a person in charge of a sales floor in the store in addition to the person in charge of customer service 49-2 as a store staff member. The person in charge of outside customers or the person in charge of the sales floor may be present not only in the business negotiation room but also on the sales floor outside the business negotiation room. The person in charge of outside customers or the person in charge of the sales floor carries the handy terminal 30 (or the mobile apparatus 31) in the same manner as the person in charge of customer service 49-2. The handy terminal 30 carried by the person in charge of outside customers or the person in charge of the sales floor may display the same content as content on the handy terminal 30 (the mobile apparatus 31) used by the person in charge of customer service 49-2 which is performing business negotiation in the business negotiation room, and may receive an instruction (a request for checking inventory, a request for bringing merchandise to the business negotiation room, or the like) from the person in charge of customer service 49-2.

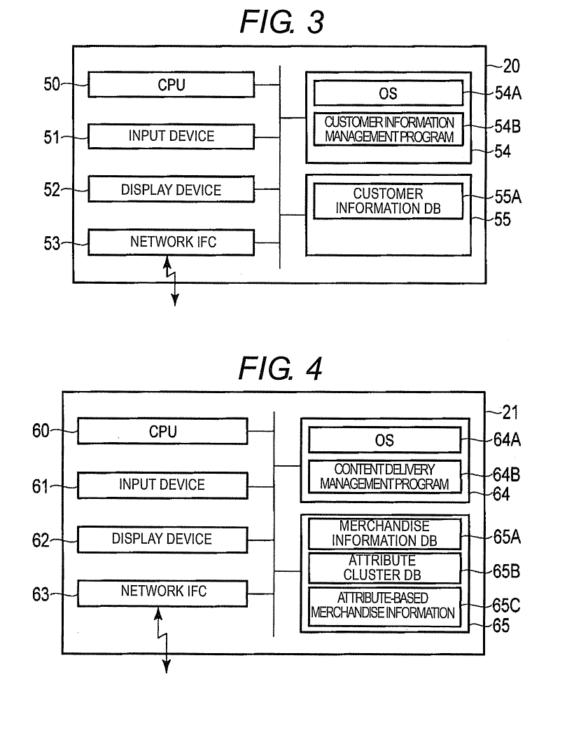

FIG. 3 is a block diagram illustrating an example of a configuration of the customer information management system 20 in the present exemplary embodiment. FIG. 3 illustrates an example in which the customer information management system 20 is realized by, for example, a single server (computer).

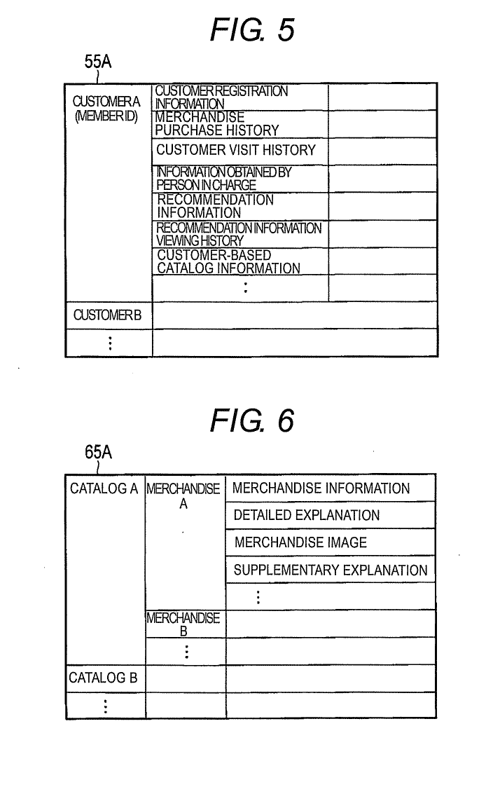

The customer information management system 20 includes, for example, a CPU 50, an input device 51, a display device 52, a network interface controller (IFC) 53, a memory 54, and a large capacity storage 55 (an HDD or an SSD). The CPU 50 reads an OS 54A or a customer information management program 54B stored in the large capacity storage 55 to the memory 54 and executes the OS or the program. The CPU 50 executes the customer information management program 54B so as to realize a function of managing customer information, merchandise purchase history, customer visit history, person-in-charge information, information (recommendation information) regarding specific merchandise for each customer, recommendation information viewing history, and the like. A customer information database 55A is recorded on the large capacity storage 55. Details of the customer information database 55A will be described later (refer to FIG. 5). The customer information management system 20 is not only realized by a single server as illustrated in FIG. 3 but may also be realized by combining a plurality of servers or other electronic apparatuses with each other.

FIG. 4 is a block diagram illustrating an example of a configuration of the content delivery system 21 in the present exemplary embodiment. FIG. 4 illustrates an example in which the content delivery system 21 is realized by, for example, a single server (computer).

The content delivery system 21 includes, for example, a CPU 60, an input device 61, a display device 62, a network interface controller (IFC) 63, a memory 64, and a large capacity storage 65 (an HDD or an SSD). The CPU 60 reads an OS 64A or a content delivery program 64B stored in the large capacity storage 65 to the memory 64 and executes the OS or the program. The CPU 60 executes the content delivery program 64B so as to realize a function of managing information (recommendation information) regarding merchandise, a function of extracting an attribute of a designated customer, a cluster management function, a recommendation information inference function, a supplementary information extraction function, and the like. A merchandise information database 65A, an attribute cluster database 65B, attribute-based merchandise information 65C, and the like are recorded on the large capacity storage 65. Details of the merchandise information database 65A, the attribute cluster database 65B, and the attribute-based merchandise information 65C will be described later. The content delivery system 21 is not only realized by a single server as illustrated in FIG. 4 but may also be realized by combining a plurality of servers or other apparatuses with each other.

FIG. 5 is a diagram illustrating an example of customer information included in the customer information database 55A of the customer information management system 20 in the present exemplary embodiment.

The customer information database 55A registers, for example, information such as customer registration information, merchandise purchase history, customer visit history, person-in-charge information, recommendation information, recommendation information viewing history, and customer-based catalog information for each customer (member ID), therein. The member ID is identification information specific to a member, issued when a customer acquires membership registration.

The customer registration information is personal information (a name, an age, a sex, a face image, and the like) submitted when the membership registration is performed. The merchandise purchase history is information regarding merchandise which was purchased in the past by the customer. The customer visit history is information which records that a customer visited the store or the business negotiation room. The person-in-charge information is information regarding a store staff member who was in charge of customer service when a customer visited the business negotiation room. The recommendation information is information regarding merchandise, delivered to a customer from the content delivery system 21. The recommendation information viewing history is information indicating history of recommendation information viewed by a customer among recommendation information pieces (content items) delivered to the customer. The customer-based catalog information is information regarding merchandise which is registered in a personal catalog and is selected from catalog type content by a customer.

FIG. 6 is a diagram illustrating an example of information included in the merchandise information database 65A of the content delivery system 21 in the present exemplary embodiment. The content delivery system 21 in the present exemplary embodiment may deliver information (recommendation information) regarding merchandise to the table terminal 32 or the tablet terminal 33, for example, in a catalog form.

The merchandise information database 65A registers a plurality of merchandise items A, B, . . . for each of a plurality of catalogs A, B, . . . therein. For example, regarding the single merchandise item A, information such as merchandise information (including a merchandise name, a price, a merchandise type number, a description of merchandise, and the like), detailed description, a merchandise image, and a supplementary description is included. Information regarding merchandise may be recorded in other forms in the merchandise information database 65A.

If recommendation information is delivered to the table terminal 32 or the tablet terminal 33 used by a customer, the content delivery system 21 extracts merchandise (merchandise cluster) recommended to the customer on the basis of the customer information, the customer attribute cluster, the merchandise cluster, and the like, and selects and delivers only information regarding the merchandise from the merchandise information database 65A. Consequently, the content delivery system 21 can selectively provide content for a customer's favorite merchandise. Therefore, the customer can easily find desired merchandise from a large number of merchandise items which are sold in the store by referring to the content (recommendation information).

The content delivery system 21 may extract merchandise (merchandise cluster) recommended to a customer on the basis of store policy information which is registered in advance by a person in charge of providing content who is a store staff member or person-in-charge information which is input from the handy terminal 30 (the mobile apparatus 31) by the person in charge of customer service 49-2 who is providing a service to the customer. Sales strategy merchandise of which the number to be sold is intended to be increased by the store side, member limited merchandise which is prepared for being provided to a member by the store, or the like is set in the store policy information. The person-in-charge information is additional information which is input from the handy terminal 30 (the mobile apparatus 31) during customer service on the basis of information obtained through conversation between, for example, the person in charge of customer service 49-2 and the customer, and is a keyword suggesting merchandise, or information indicating additional information (keyword) or priority (weight).

The content delivery system 21 may extract merchandise (merchandise cluster) recommended to a customer on the basis of a customer's additional request which is input from the reception device 16 by the customer during business negotiation with the person in charge of customer service 49-2. The user's additional requests may be repeatedly input from the reception device 16 while the customer receives services from the person in charge of customer service 49-2. For example, the customer inputs an image, text data, a sound, or the like related to desired merchandise so as to give an instruction for a keyword suggesting the merchandise to the content delivery system 21 as a customer's additional request.

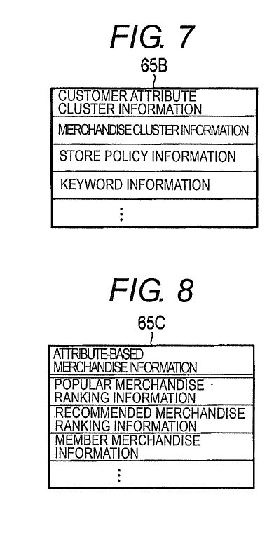

FIG. 7 is a diagram illustrating an example of information included in the attribute cluster database 65B of the content delivery system 21 in the present exemplary embodiment.

The attribute cluster database 65B includes, for example, customer information cluster information, merchandise cluster information, store policy information, keyword information, and the like. The customer information cluster information is used to determine characteristics of a customer on the basis of information regarding the customer, and includes, for example, cluster information such as a population statistics cluster, a preference cluster, and a behavior cluster. The merchandise cluster information is used to determine a merchandise group related to the customer attribute cluster, the person-in-charge information, the store policy, and the customer's additional request, and is information related to a merchandise cluster corresponding to each of a plurality of merchandise groups. The store policy information is information indicating sales strategy merchandise registered by the person in charge of providing content who is a store staff member, member limited merchandise, or the like. The keyword information is information regarding a keyword suggesting merchandise specified by text which is input by the person in charge of customer service 49-2 or the like or by an image, text, a sound, or the like designated by a customer.

FIG. 8 is a diagram illustrating an example of the attribute-based merchandise information 65C included in the attribute cluster database 65B of the content delivery system 21 in the present exemplary embodiment.

The attribute-based merchandise information 65C includes, for example, popular merchandise ranking information, recommended merchandise ranking information, member merchandise information, and the like. The attribute-based merchandise information 65C may be registered on the basis of, for example, merchandise sales results managed by the POS system 22 or an inventory situation managed by the inventory management system 23. The information included in the attribute-based merchandise information 65C may be used as, for example, store policy, and may be used to extract merchandise (merchandise cluster) corresponding to a customer.

Next, a description will be made of an operation of the customer service system 10 in the present exemplary embodiment.

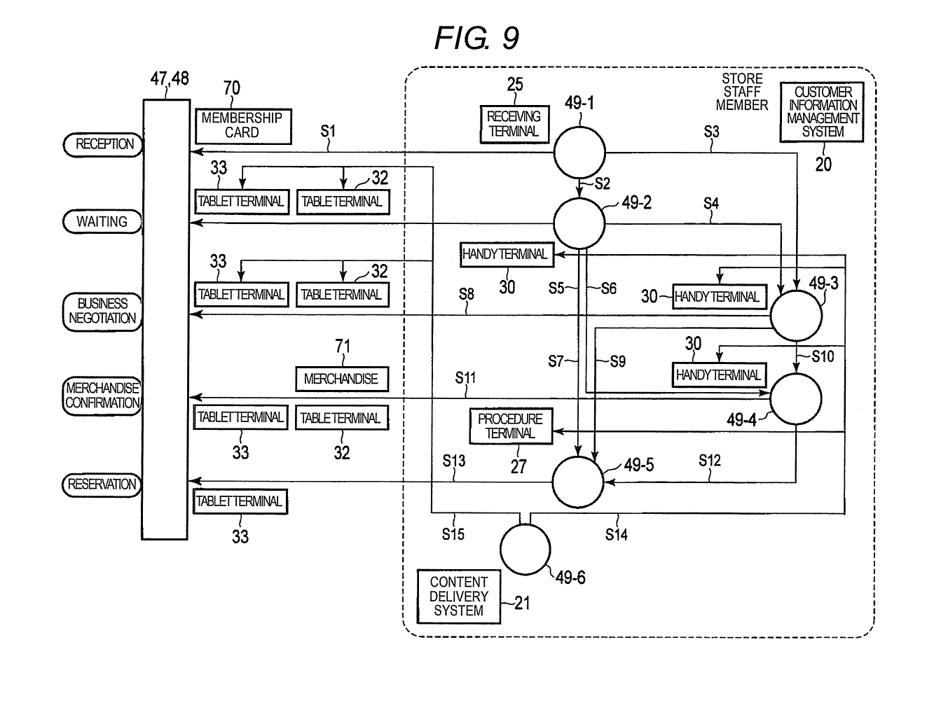

FIG. 9 is a diagram illustrating a flow of information which is transmitted and received between a store staff member and a customer in the customer service system 10 of the present exemplary embodiment.

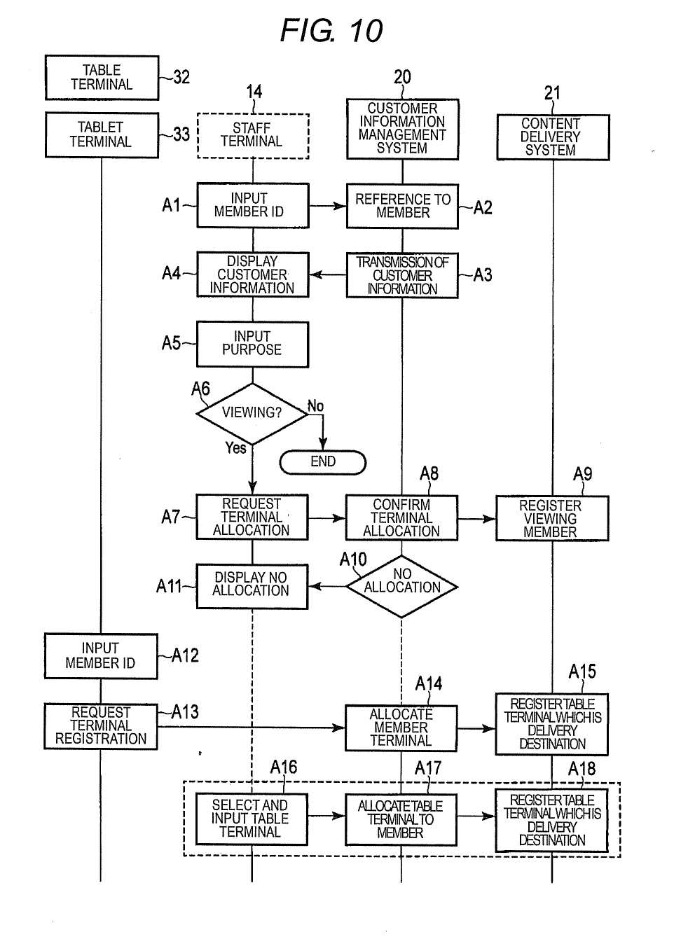

First, with reference to a flowchart illustrated in FIG. 10, a description will be made of a process of allocating a process in which the reception device 16 (the tablet terminal 33 and the table terminal 32) is allocated to a customer visiting the business negotiation room.

If the customer visits the business negotiation room, the person in charge of reception 49-1 acquires authentication information for confirming a member from the customer (Act 1 in FIG. 9). For example, the person in charge of reception 49-1 deposits a membership card of the customer, and inputs a member ID recorded on the membership card from the receiving terminal 25. If the member ID is input, the staff terminal 14 (the receiving terminal 25) transmits the member ID to the customer information management system 20 (Act A1 in FIG. 10). The authentication information is not limited to a member ID, and may be, for example, biometrics of a customer.

If the member ID is received from the receiving terminal 25, the customer information management system 20 makes a member inquiry on the basis of the member ID (Act A2). In other words, the customer information management system 20 searches the customer information database 55A on the basis of the member ID and extracts customer information corresponding to the member ID. The customer information management system 20 selects information necessary in a reception procedure from the customer information extracted from the customer information database 55A and transmits the information to the receiving terminal 25 (Act A3). For example, the customer information management system 20 transmits customer registration information (a name, a sex, an age, a face image, and the like), customer visit history, person-in-charge information, and the like.

The receiving terminal 25 receives the customer information from the customer information management system 20 and displays the customer information on the display device (Act A4).

Next, the person in charge of customer service 49-2 confirms that the customer is a member on the basis of the information displayed on the receiving terminal 25 and asks the customer a purpose of the visit. For example, the purpose of the visit includes purchase of desired merchandise or purchase of a gift. The receiving terminal 25 inputs information indicating the customer's purpose in response to an operation performed by the person in charge of customer service 49-2 (Act A5). The receiving terminal 25 determines whether or not content delivered from the content delivery system 21 is required to be viewed (Act A6). Here, if it is determined that viewing is not necessary, the receiving terminal 25 finishes a process of allocating the tablet terminal 33.

On the other hand, if it is determined that viewing is necessary, the receiving terminal 25 transmits a request for allocating a terminal to the customer (member ID) who is currently treated as a reception target to the customer information management system 20 (Act A7). The customer information management system 20 checks whether or not a terminal is allocated to the target customer (member ID) in response to the request for allocating a terminal (Act A8). Here, if it is determined that a terminal is not allocated (Act A10), the customer information management system 20 notifies the receiving terminal 25 that a terminal is not allocated. The receiving terminal 25 displays the notification content indicating that the tablet terminal 33 is not allocated to the target customer (Act A11).

The customer information management system 20 notifies the content delivery system 21 of the customer (member ID) treated as a reception target in response to the terminal allocation request from the receiving terminal 25. The content delivery system 21 registers the customer (member ID) of which the notification is sent from the customer information management system 20 as a customer who views content regarding merchandise (Act A9).

If the person in charge of reception 49-1 confirms that the tablet terminal 33 is not allocated to the customer through the display on the receiving terminal 25, the person in charge of reception 49-1 inputs the member ID of the customer (or other specific information such as the name of the customer) to the tablet terminal 33 which is lent to the customer, and gives an instruction for registering the terminal (Act A12). The receiving terminal 25 transmits the input member ID and the terminal registration request to the customer information management system 20 in response to an operation performed by the person in charge of reception 49-1 (Act A13).

The customer information management system 20 allocates the tablet terminal 33 requesting the terminal registration to a customer (member ID) who is a target of a previously received terminal allocation request (Act A14). The customer information management system 20 notifies the content delivery system 21 of the tablet terminal 33 allocated to the customer (member ID). The content delivery system 21 registers the tablet terminal 33 which is a delivery destination of content in correlation with the customer who views the content. Consequently, the content delivery system 21 can deliver information (recommendation information) regarding merchandise recommended to the customer to the tablet terminal 33 which is lent to the customer and can receive a request from the customer via the tablet terminal 33.

The table terminal 32 may be allocated to the customer. If the table terminal 32 allocated to the customer is selected through an operation performed by the person in charge of reception 49-1 (Act A16), the seat allocation terminal 26 transmits a table terminal allocation request to the customer information management system 20 along with information (table identification information) indicating the table terminal 32 and the customer (member ID).

The customer information management system 20 allocates the table terminal 32 indicated by the table identification information received from the seat allocation terminal 26 to a customer (member ID) treated as a target of a previously received terminal allocation request (Act A17). The customer information management system 20 notifies the content delivery system 21 of the table terminal 32 allocated to the customer (member ID). The content delivery system 21 registers the table terminal 32 which is a delivery destination of content in correlation with the customer who views the content. Consequently, the content delivery system 21 can deliver information (recommendation information) regarding merchandise recommended to the customer to the table terminal 32 which is allocated to the customer and can receive a request from the customer via the table terminal 32.

The person in charge of reception 49-1 may allocate the table seat 46 to a customer who lends the tablet terminal 33. In this case, the person in charge of reception 49-1 operates the seat allocation terminal 26 so as to input table identification information (a table number or the like) indicating the table seat 46 and to notify the customer information management system 20 of the information. The customer information management system 20 transmits the table identification information, and the customer registration information (a name, a sex, an age, and the like), the customer visit history, the person-in-charge information, and the like included in the customer information, to the staff terminal 14. Consequently, the handy terminal 30 carried by, for example, the person in charge of customer service 49-2 displays the table identification information and the customer information. The person in charge of customer service 49-2 confirms the table identification information and the customer information displayed on the handy terminal 30 and can provide a service to the customer 47 to which the tablet terminal 33 is not lent.

As illustrated in FIG. 9, the customer information management system 20 notifies the staff terminal 14 carried by a store staff member (for example, the person in charge of customer service 49-2 or the person in charge of outside customers 49-3) that a customer visits the business negotiation room on the basis of the information which is input from the receiving terminal 25 and the seat allocation terminal 26 during the reception (Acts 2 and 3). For example, the customer information management system 20 notifies the staff terminal 14 of the customer coming into the room and also notifies (including confirmation of an outside customer schedule, or the like) the staff terminal 14 of a visit purpose, thereby instructing a store staff member to provide a service to the customer.

In the above description, the table terminal 32 or the tablet terminal 33 prepared by the store side is allocated to a customer, but a mobile apparatus 34 such as a smartphone owned by a customer may be used as the reception device 16. In this case, the receiving terminal 25 installs an application program (a content viewing application or an operation application) for realizing a function equivalent to the function of the tablet terminal 33 in the mobile apparatus 34 of the customer. The mobile apparatus 34 executes the application program so as to communicate with the customer information management system 20 or the content delivery system 21 via a network in a rest room.

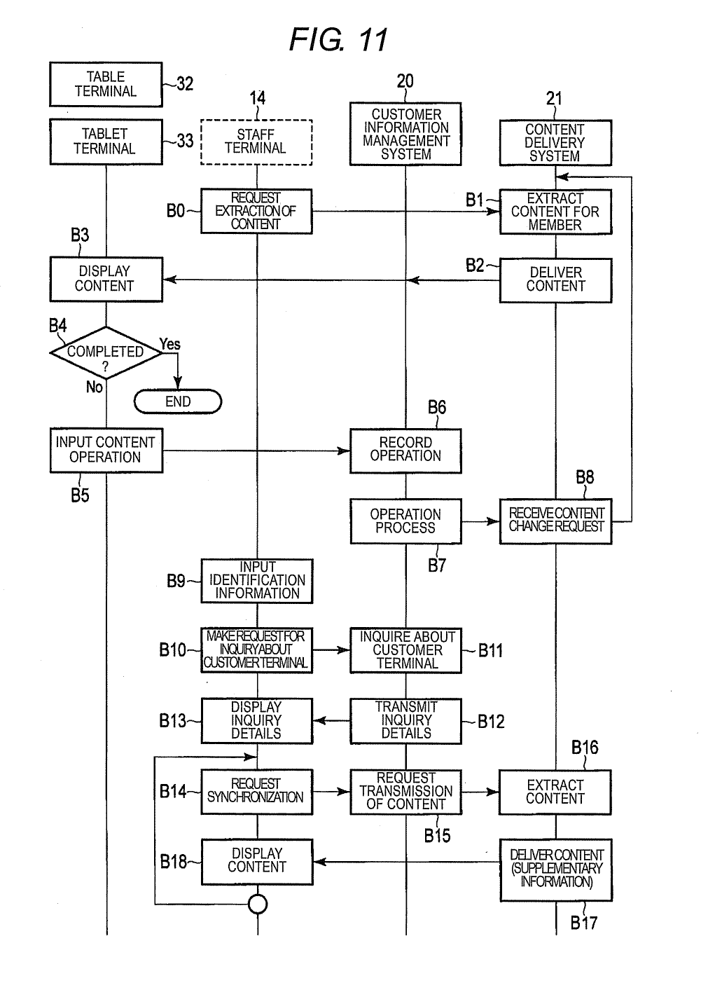

Next, with reference to a flowchart illustrated in FIG. 11, a description will be made of a process in which content displayed on the tablet terminal 33 (the table terminal 32) lent to a customer is synchronized with content displayed on the handy terminal 30 carried by the person in charge of customer service 49-2.

The person in charge of reception 49-1 confirms a purpose of the customer 47 coming into the room and then gives an instruction for a content extraction request from the receiving terminal 25 (or the seat allocation terminal 26) if it is determined that content for the customer is required to be prepared. The receiving terminal 25 transmits the content extraction request to the content delivery system 21 (Act B0). If the content extraction request is received, the content delivery system 21 extracts content for a customer (member) who will view the content (Act B1).

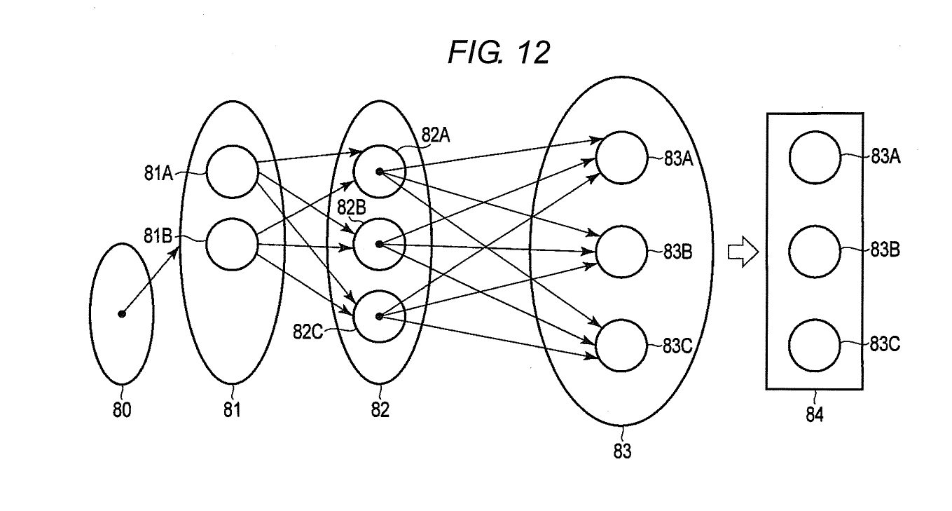

FIG. 12 is a diagram for explaining extraction of content for a customer performed by the content delivery system 21 in the present exemplary embodiment. As illustrated in FIG. 12, the content delivery system 21 extracts a merchandise group (merchandise cluster) which is expected to be a customer's favorite merchandise on the basis of the relational strength (or the distance) between a customer attribute cluster 82 corresponding to a customer and a merchandise cluster 83 by using, for example, a cluster analysis method. The content delivery system 21 generates content for the merchandise group (merchandise cluster) expected to be the user's favorite merchandise, that is, information displayed on the staff terminals 14, the table terminal 32 or the tablet terminal 33 and delivers the information. In the present exemplary embodiment, the content delivered from the content delivery system 21 is assumed to be generated, for example, in a merchandise catalog form.

First, the content delivery system 21 extracts customer information 81 on the basis of a member ID 80 of the customer. The customer information 81 includes, for example, registration information 81A and purchase history 81B. The content delivery system 21 determines the customer attribute cluster 82 corresponding to the registration information 81A or the purchase history 81B of the customer and extracts the merchandise cluster 83 having high relational strength with the customer attribute cluster 82.

The customer attribute cluster 82 includes, for example, a population statistics cluster 82A, a preference cluster 82B, a behavior cluster 82C, a hobby, lifestyle information, and sightseeing guidance. For example, if information regarding “the age of forty” and “female” is obtained from the registration information 81A of the customer, and information regarding “brand of purchased merchandise” and “the number of yearly purchases” is obtained from the purchase history 81B, the content delivery system 21 increases relational strength for a merchandise cluster of merchandise preferred by “females” having the “age of forty” on the basis of the population statistics cluster 82A, a merchandise cluster of merchandise corresponding to the “brand of purchased merchandise” on the basis of the preference cluster 82B, and a merchandise cluster of merchandise which is purchased at a frequency corresponding to the “number of yearly purchases” on the basis of the behavior cluster 82C.

The content delivery system 21 calculates relational strength between each of the cluster 82A, . . . of the customer attribute cluster 82 and the clusters 83A, 83B, 83C, . . . corresponding to each item of merchandise of the merchandise cluster 83, and extracts a higher-rank merchandise cluster for which a sum of relational strengths between the respective clusters is predefined. FIG. 12 illustrates merchandise clusters 83A, 83B and 83C up to the third rank from the top as extracted merchandise clusters 84. The content delivery system 21 generates content items (merchandise catalog) associated with merchandise items corresponding to the merchandise clusters 83A, 83B and 83C as customer-based recommendation information.

The content delivery system 21 records the extracted merchandise clusters, relational strength breakdown with the customer attribute clusters related to the merchandise clusters, a customer attribute cluster belonging to a higher rank in breakdown, relational strength breakdown of a customer attribute related to the customer attribute cluster, customer attribute information belonging to a higher rank in breakdown, and the like, as supplementary information which is delivered to the staff terminal 14. The content delivery system 21 provides a selection factor of a step for extracting a merchandise cluster or an extent of influence of the selection factor to the person in charge of customer service 49-2 as supplementary information (processes in Acts B17 and B18 to be described later). Consequently, an explanation of merchandise (content) recommended to the customer can be given during customer service.

The content delivery system 21 delivers the content (recommendation information) corresponding to the customer to the tablet terminal 33 (or the table terminal 32) lent to the customer (Act B2). If the content (recommendation information) delivered from the content delivery system 21 is received, the tablet terminal 33 displays the content on the display device in a catalog form (Act B3).

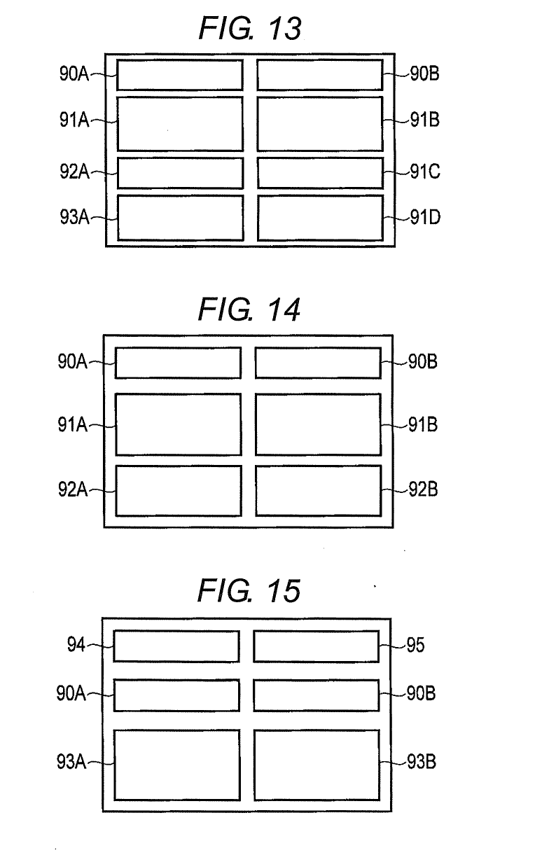

FIGS. 13 and 14 are diagrams illustrating display examples of content which is displayed on the tablet terminal 33 in the present exemplary embodiment. FIGS. 13 and 14 illustrate examples in which merchandise catalogs of two merchandise items (merchandise A and merchandise B) are disposed and displayed on the left and right parts of a single screen in the tablet terminal 33.

In FIG. 13, regarding the merchandise A, the merchandise title and summary 90A, a merchandise picture 91A, the merchandise detailed description 92A, and the supplementary information description 93A are displayed, and, regarding the merchandise B, the merchandise title and summary 90B, the merchandise picture 91B, the merchandise detailed description 92B, and the supplementary information description 93B are displayed. In this case, many information pieces are displayed on the single screen, and thus a character size of the text or an image size is small. Therefore, some customers may feel that details of the content are inconvenient to view.

In FIG. 14, regarding the merchandise A, a merchandise title and summary 90A, a merchandise picture 91A, and a merchandise detailed description 92A, are displayed, and, regarding the merchandise B, a merchandise title and summary 90B, a merchandise picture 91B, and a merchandise detailed description 92B are displayed. In the display form illustrated in FIG. 14, the supplementary information descriptions 93A and 93B are omitted from the display form illustrated in FIG. 13, and thus spaces for the merchandise pictures 91A and 91B and the merchandise detailed descriptions 92A and 92B can be widened. Therefore, details of the content items can be easily viewed. The customer service system 10 of the present exemplary embodiment fundamentally displays content items on the tablet terminal 33 (the table terminal 32) in the display form illustrated in FIG. 14. The supplementary information descriptions 93A and 93B omitted from the display on the tablet terminal 33 may be displayed on the staff terminal 14 through synchronization between the tablet terminal 33 and the staff terminal 14.

FIG. 15 illustrates an example in which content is displayed on the staff terminal 14 (the handy terminal 30) in synchronization with the tablet terminal 33 according to the present exemplary embodiment.

As illustrated in FIG. 15, the handy terminal 30 displays the merchandise titles and summaries 90A and 90B, and the supplementary information descriptions 93A and 93B so as to correspond to the content items of the merchandise items A and B displayed on the tablet terminal 33. In addition, the handy terminal 30 displays a device designation area 95 for displaying a button used to designate the reception device 16 which will be used by a customer treated as a service target by the person in charge of customer service 49-2 or for displaying identification information or the like of the reception device 16 (the table terminal 32 and the tablet terminal 33) in which synchronization is set. The handy terminal 30 is synchronized with the tablet terminal 33 and thus displays member information 94 of a current customer treated as a service target.

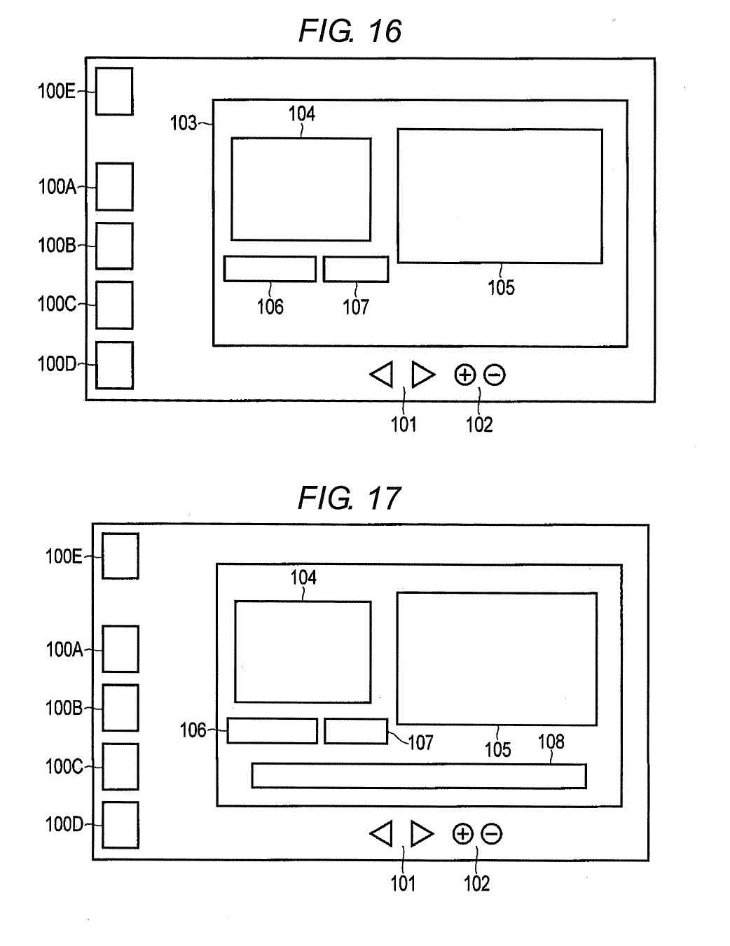

The tablet terminal 33 can change display details through an operation of content items until the customer instructs viewing of the content to be finished (Act B4). For example, buttons for giving instructions for selection of a catalog type, page switching, addition of content (merchandise) to favorites (customer-based catalog) during display, purchase of merchandise, and the like are added to the content displayed on the tablet terminal 33 (refer to FIG. 16). The customer can operate the buttons by touching a display surface on the tablet terminal 33 with the fingertip. If the buttons added to the content are operated by the customer (Act B5), the tablet terminal 33 notifies the customer information management system 20 of the operation content.

The customer information management system 20 records the operation details performed by the customer (Act B6), and performs a process corresponding to the operation (Act B7). For example, if an instruction for addition to favorites (customer-based catalog) is received, the customer information management system 20 performs a process of adding merchandise to customer-based catalog information. If an instruction for purchase of merchandise is received, the customer information management system 20 transmits information (customer information, merchandise information, and the like) necessary in a merchandise purchase procedure to the procedure terminal 27.

If an instruction for a content change such as selection of a catalog type or page switching is received (if there is a request for changing content from the reception device 16), the customer information management system 20 transmits a content change request to the content delivery system 21. If the content change request is received (Act B8), the content delivery system 21 extracts new content to be delivered to the customer according to the request details (Act B1), and delivers the content to the tablet terminal 33 as described above (Act B2).

FIG. 16 is a diagram illustrating a display example of content which is displayed on the tablet terminal 33 in the present exemplary embodiment.

In a display form illustrated in FIG. 16, content 103 of a single merchandise item is included. The content 103 includes a merchandise title and summary 104, and a merchandise picture 105. A page switching button 101 for giving an instruction for page switching and an enlargement and reduction button 102 for giving an instruction for enlargement or reduction of display are provided on a lower part of the content 103. A plurality of catalog buttons 100A, 100B, 100C and 100D for selecting a catalog, and a catalog button 100E for selecting a customer-based catalog are provided on a left side of the content 103.

The content includes a “favorite” button 106 and a “purchase” button 107. If the “favorite” button 106 is operated, the tablet terminal 33 displays a message 108, for example, “the merchandise is added to the customer-based catalog” as illustrated in FIG. 17. In addition to the buttons illustrated in FIG. 16, buttons such as a “merchandise confirmation” button for making a request for confirming actual merchandise, a “reservation” button for giving an instruction for reservation of merchandise purchase, and the like may be added.

As mentioned above, if the tablet terminal 33 is lent, the customer can view content (recommendation information) regarding merchandise extracted for the customer in a catalog form. While the customer is waiting for a seat in the waiting space 44 to be unoccupied or is sitting in the business negotiation space, the customer can view any information regarding merchandise or register merchandise in favorites (customer-based catalog) by operating the tablet terminal 33.

A customer enters the business negotiation space and can continue the viewing in the waiting space 44. If the customer is allocated the table terminal 32, the customer can view content on the table terminal 32 as well as on the tablet terminal 33. The content displayed on the table terminal 32 is provided with buttons and the like for inputting operations performed by the customer in the same manner as in the above-described tablet terminal 33. In this case, if content is changed by operating the table terminal 32, the content displayed on the tablet terminal 33 is also changed in interlocking with the change.

The content delivery system 21 may deliver different content items to the tablet terminal 33 and the table terminal 32. For example, content of merchandise selected by a customer may be displayed on the tablet terminal 33, and content of supplementary merchandise related to the merchandise displayed on the tablet terminal 33 may be displayed on the table terminal 32. Consequently, the large display screen of the table terminal 32 is effectively used, and thus content items of a plurality of merchandise items can be simultaneously displayed, and a customer can easily compare the merchandise items with each other.

If a customer sits on the table seat 46 or the seat of the table terminal 32, the customer can receive a service from the person in charge of customer service 49-2 or the person in charge of outside customers 49-3. For example, the person in charge of customer service 49-2 may perform a procedure for synchronizing content displayed on the tablet terminal 33 (the table terminal 32) used by the customer with content displayed on the handy terminal 30 prior to customer service. Hereinafter, a case where the customer uses the tablet terminal 33 will be described as an example. The table terminal 32 is used in the same manner as in the tablet terminal 33, and thus description thereof will be omitted.

First, the person in charge of customer service 49-2 operates the handy terminal 30 so as to input identification information for specifying the tablet terminal 33 used by the customer or the customer (Act B9). As the identification information, for example, a two-dimensional code (QR code (registered trademark) or the like) specific to the terminal, attached to the tablet terminal 33, table identification information (a table number or the like), a member ID, a member name, and table position information may be used. The two-dimensional code may be input, for example, by imaging the two-dimensional code with a camera provided in the handy terminal 30. The two-dimensional code may be displayed on the tablet terminal 33. For example, the person in charge of customer service 49-2 may operate the handy terminal 30 so as to input other information pieces. The person in charge of customer service 49-2 may cause the handy terminal 30 to come close to the tablet terminal 33, and thus identification information of the tablet terminal 33 may be received by using near field wireless communication.

The handy terminal 30 transmits the input identification information and a customer terminal inquiry request to the customer information management system 20 (Act B10). The customer information management system 20 inquires about the tablet terminal 33 on the basis of the identification information, and extracts information (table identification information or position information) regarding the tablet terminal 33, or customer registration information (a name, a sex, an age, a face image, and the like), customer visit history, and person-in-charge information included in customer information regarding the customer using the tablet terminal 33 (Act B11). The customer information management system 20 transmits the inquiry details extracted on the basis of the identification information, to the handy terminal 30 (Act B12).

The handy terminal 30 displays the inquiry details received from the customer information management system 20 (Act B13). The person in charge of customer service 49-2 can confirm that the customer information management system 20 is accurately notified of the tablet terminal 33 used by the customer by referring to the inquiry details displayed on the handy terminal 30.

Here, the person in charge of customer service 49-2 operates the handy terminal 30 so as to give an instruction for synchronization with the tablet terminal 33 used by the customer. In other words, content items of the same merchandise are instructed to be simultaneously displayed on the tablet terminal 33 and the handy terminal 30. The handy terminal 30 transmits a content synchronization request to the customer information management system 20 in response to the operation performed by the person in charge of customer service 49-2 (Act B14).

If the content synchronization request is received, the customer information management system 20 transmits a content transmission request to the content delivery system 21 along with information indicating the tablet terminal 33 about which the inquiry was made previously on the basis of identification information (Act B15).

The content delivery system 21 determines merchandise having the content (recommendation information) delivered to the tablet terminal 33 on the basis of the information indicating the tablet terminal 33, received from the customer information management system 20. The content delivery system 21 extracts content for a store staff member (for example, the person in charge of customer service 49-2) corresponding to the determined merchandise (Act B16), and delivers the content to the handy terminal 30 which transmits the synchronization request (Act B17). For example, the handy terminal 30 used by the person in charge of customer service 49-2 includes member information, a supplementary information description, or the like which is not displayed on the tablet terminal 33, as illustrated in FIG. 15. The handy terminal 30 displays the content received from the content delivery system 21 on the display device (Act B18).

In the example illustrated in FIG. 11, the person in charge of customer service 49-2 gives an instruction for a synchronization request to the handy terminal 30, and thus the content of the same merchandise having the content displayed on the tablet terminal 33 used by the customer is displayed on the handy terminal 30. However, after a synchronization request is initially received, and the handy terminal 30 and the tablet terminal 33 (the table terminal 32) are correlated with each other, the content delivery system 21 may automatically switch content on the handy terminal 30 to the content corresponding to the same merchandise in response to a change of the content displayed on the tablet terminal 33 (the table terminal 32) even if there is no instruction for the synchronization request.

The content delivery system 21 may not only switch content displayed on the handy terminal 30 in response to a change of content displayed on the tablet terminal 33 (the table terminal 32) but may also automatically switch content displayed on the tablet terminal 33 (the table terminal 32) in response to a change of content displayed on the handy terminal 30. Consequently, the person in charge of customer service 49-2 operates the handy terminal 30, and thus content of merchandise which is intended to be viewed by the customer can be displayed on the tablet terminal 33 (the table terminal 32).

In the above-described manner, when the person in charge of customer service 49-2 performs customer service, the tablet terminal 33 used by the customer is synchronized with the handy terminal 30 used by the person in charge of customer service 49-2, and thus content items of the same merchandise can be simultaneously displayed without performing complex operations. For example, there is no need for an operation in which the customer checks merchandise which is being viewed on the tablet terminal 33, and the person in charge of customer service 49-2 switches a page of a merchandise catalog displayed on the handy terminal 30 and finds content of the same merchandise. Consequently, time and effort of the person in charge of customer service 49-2 can be considerably reduced, and thus time required to operate the handy terminal 30 can be reduced.

The handy terminal 30 displays content of the same merchandise in synchronization with content displayed on the tablet terminal 33, but may display a content item including different details. For example, supplementary information regarding merchandise, which is not displayed on the tablet terminal 33, may be displayed on the handy terminal 30, and thus the person in charge of customer service 49-2 can give a detailed explanation of the merchandise to the customer by referring to the supplementary information.

For example, the content delivery system 21 generates content (supplementary information) for a store staff member on the basis of a selection factor of a step for extracting a merchandise cluster when generating content corresponding to a customer (merchandise catalog), or an extent of influence of the selection factor, and delivers the content to the handy terminal 30. Specifically, a message, for example, “presentation of AA series of the BB bag having the CC brand indicates the time to purchase a bag since the brand belongs to a higher popularity ranking with women over 40 and is a customer's favorite brand as a rare item, and the customer purchases about two bags every year”, is generated.

The person in charge of customer service 49-2 checks the supplementary information (message) displayed on the handy terminal 30, and can give a detailed explanation of the reason why merchandise in a merchandise catalog displayed on the tablet terminal 33 is recommended to the customer. Consequently, the person in charge of customer service 49-2 can easily prompt the customer to purchase the merchandise.

In the above description, a case is assumed in which the person in charge of customer service 49-2 provides a service to a single customer. However, the person in charge of customer service 49-2 may provide services to a plurality of customers who sit on a plurality of different table seats 46 or the seats of the table terminals 32. For this reason, the content delivery system 21 correlates the handy terminal 30 used by the person in charge of customer service 49-2 with the tablet terminals 33 used by customers in response to a synchronization request from the handy terminal 30, and records correspondence relationships between the handy terminal 30 and the tablet terminals 33. If the person in charge of customer service 49-2 simultaneously provides services to a plurality of customers, the tablet terminal 33 used by each of the customers may be synchronized with the handy terminal 30. The handy terminal displays identification information (or, for example, customer registration information for identifying the customer) of the tablet terminal 33 of which the correspondence relationship is recorded by the content delivery system 21 on, for example, the device designation area 95 illustrated in FIG. 15. The person in charge of customer service 49-2 selects identification information corresponding to the customer displayed on the device designation area 95 according to a customer treated as a service target. The handy terminal 30 notifies the content delivery system 21 of the identification information selected by the person in charge of customer service 49-2. The content delivery system 21 switches content delivered to the handy terminal 30 so as to be synchronized with the tablet terminal 33 corresponding to the identification information according to the identification information of which a notification is sent from the handy terminal 30.

In the above-described way, the person in charge of customer service 49-2 can provide services to a plurality of customers by using the single handy terminal 30. If the customer service is completed, the person in charge of customer service 49-2 selects the identification information displayed on the device designation area 95 of the handy terminal 30 and also gives an instruction for completing the customer service. The handy terminal 30 notifies the content delivery system 21 of the customer service completion along with the identification information. The content delivery system 21 deletes the correspondence relationship with the table terminal 32 and the tablet terminal 33 indicated by the identification information in response to the notification of the customer service completion.

In the above description, synchronization between the tablet terminal 33 (the table terminal 32) used by a customer and the handy terminal 30 used by the person in charge of customer service 49-2 is described, but the handy terminals 30 used by other store staff members may also be synchronized in the same manner.

The person in charge of outside customers 49-3 illustrated in FIG. 9 displays content on the handy terminal 30 in synchronization with the table terminal 32 used by a customer during business negotiation with the customer in the same manner as the above-described person in charge of customer service 49-2, and can thus perform the business negotiation while viewing the content displayed on the handy terminal 30 (Act 8).

The handy terminal 30 used by the person in charge of customer service 49-2 or the person in charge of outside customers 49-3 can communicate with, for example, the handy terminal 30 used by the person in charge of sales floor 49-4 and the procedure terminal 27 used by the person in charge of procedure 49-5 via the customer information management system 20 or the content delivery system 21. For example, the person in charge of customer service 49-2 or the person in charge of outside customers 49-3 can notify the person in charge of sales floor 49-4 or the person in charge of procedure 49-5 of an inventory checking request or a request for bringing actual merchandise during business negotiation with a customer via the handy terminal 30 (Acts 6, 7, 9 and 10). The person in charge of customer service 49-2 gives an instruction for an inventory checking request or a request for bringing actual merchandise in a state in which content of the merchandise which the customer is considering purchasing is displayed. The handy terminal 30 notifies the content delivery system 21 of the inventory checking request or the request for bringing actual merchandise along with merchandise information corresponding to the merchandise content. The content delivery system 21 delivers content corresponding to the merchandise information received from the handy terminal 30 to the handy terminal 30 used by the person in charge of sales floor 49-4 or the procedure terminal 27, and also sends a notification of the inventory checking request or the request for bringing actual merchandise.

The content delivery system 21 does not only delivers content of merchandise which the customer is considering purchasing to the handy terminal 30 used by the person in charge of sales floor 49-4 or the procedure terminal 27 but also displays merchandise content of merchandise items related to the merchandise which the customer is considering purchasing. The related merchandise items include, for example, merchandise of which a size or a color is different from a size or a color of the merchandise which the customer is considering purchasing, merchandise which is used in combination with the merchandise which the customer is considering purchasing, and merchandise for which sales promotion progresses in a store related to the merchandise which the customer is considering purchasing. If content of the related merchandise is included and is delivered, for example, the person in charge of sales floor 49-4 can not only recommend the merchandise which the customer is considering purchasing but can also bring related merchandise 71 (actual merchandise) to the business negotiation room and recommend the merchandise to the customer (Act 11). If there is no inventory of the merchandise which the customer is considering purchasing, the person in charge of procedure 49-5 may take related merchandise to the business negotiation room and recommend the merchandise (actual merchandise) to the customer.

If a customer decides to reserve or purchase merchandise, an instruction for reservation or purchase of the merchandise may be given from the tablet terminal 33 used by the customer, or the handy terminal 30 used by the person in charge of customer service 49-2, the person in charge of outside customers 49-3, or the person in charge of sales floor 49-4 (Act 12). The customer information management system 20 and the content delivery system 21 are notified of the instruction for reservation or purchase of merchandise. Therefore, information (a merchandise name, a merchandise type number, and the like) regarding the merchandise which is a purchase target or information regarding the customer is transmitted from the customer information management system 20 and the content delivery system 21 to the procedure terminal 27. For this reason, there is no need for the customer or the person in charge of procedure 49-5 to input various information pieces to the procedure terminal 27 in order to perform a procedure of purchasing the merchandise. The person in charge of procedure 49-5 can confirm the reservation or the purchase of the merchandise with the customer while viewing information regarding the merchandise and information regarding the customer displayed on the procedure terminal 27 (Act 13).

In the above-described way, the handy terminal 30 used by a store staff member is synchronized with the tablet terminal 33 (the table terminal 32) used by a customer, and thus information regarding a customer treated as a service target or information regarding merchandise can be shared. Therefore, procedure work such as reception, customer service, business negotiation, confirmation of merchandise, and payment can be made efficient, and thus work burdens on a customer and a store staff member can be reduced.

Next, a description will be made of a change of content (recommendation information) which is provided from the content delivery system 21 to the tablet terminal 33 (the table terminal 32).

In the above description, as illustrated in FIG. 9, the content delivery system 21 extracts a merchandise cluster of merchandise cluster recommended to a customer on the basis of a relationship between the customer information 81, the customer attribute cluster 82, and the merchandise cluster 83 according to the member ID 80 of the customer visiting the business negotiation room, and the customer information 81 and the customer attribute cluster 82 are not information which greatly changes over time. Therefore, a relationship between the customer attribute cluster 82 and the merchandise cluster 83 also does not greatly change, and thus merchandise recommended to the customer is the same at all times.

The customer service system 10 of the present exemplary embodiment inputs information (person-in-charge information) obtained by a store staff member through conversation with a customer, or information (store policy information) indicating information regarding store policy from the staff terminal 14, and can thus change merchandise (recommendation information) recommended to the customer. The person-in-charge information includes, for example, a customer's desire, a customer's preference, and a visit purpose. The store policy information includes sales strategy merchandise of which the number to be sold is intended to be increased by the store side, member limited merchandise which is prepared for being provided to a member by the store, or the like.

In the customer service system 10, for example, an additional request which is made when a customer receives service from a store staff member is input from the tablet terminal 33 (the table terminal 32), and thus merchandise (recommendation information) recommended to the customer can be changed in the same manner.

In other words, the customer service system 10 of the present exemplary embodiment can change content (recommendation information) delivered to the tablet terminal 33 (the table terminal 32) used by a customer on the basis of various information pieces which are input from a plurality of staff terminals 14 and the tablet terminal 33 (the table terminal 32). Consequently, information regarding merchandise which is suitable for a customer's desire can be appropriately provided, and the customer may desire to purchase the merchandise.

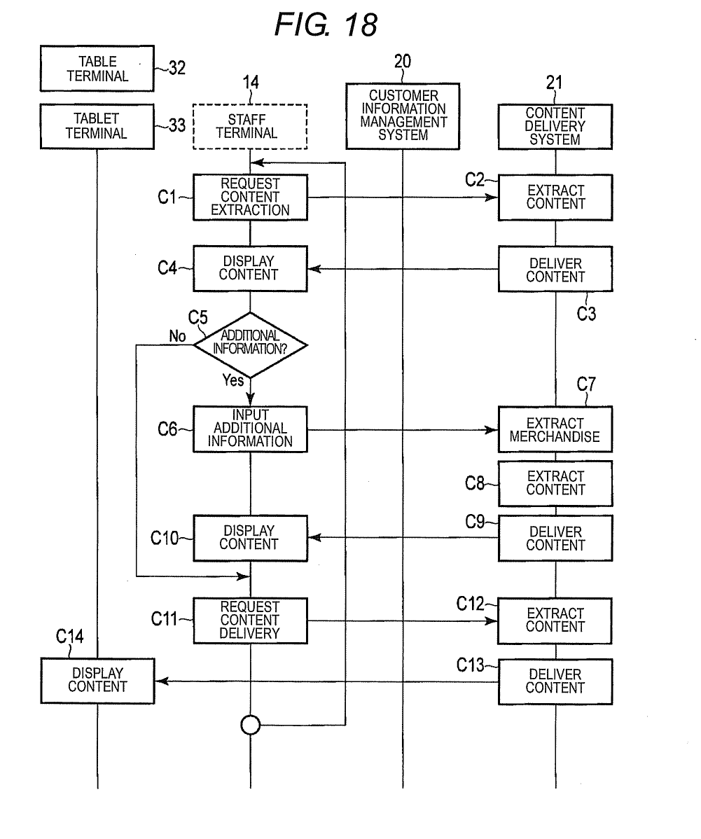

First, with reference to a flowchart illustrated in FIG. 18, a description will be made of a process for changing content (recommendation information) on the basis of information which is input from the staff terminal 14.

Herein, a case where person-in-charge information (additional information) is input by the person in charge of customer service 49-2 during customer service will be described as an example. If content of merchandise recommended to a customer treated as a service target is required to be viewed, the person in charge of customer service 49-2 gives an instruction for a content extraction request to the handy terminal 30. The handy terminal 30 transmits the content extraction request to the content delivery system 21 in response to the instruction from the person in charge of customer service 49-2 (Act C1). The content delivery system 21 extracts content for the merchandise recommended to the customer (member) who views the content in response to the content extraction request (Act C2). The content delivery system 21 delivers the extracted content to the handy terminal 30 (Act C3). The handy terminal 30 displays the content delivered from the content delivery system 21. The content displayed on the handy terminal 30 is synchronized with content displayed on the tablet terminal 33 which is used by the customer treated as a service target as described above.

If the person in charge of customer service 49-2 obtains effective information necessary to narrow down merchandise items desired by the customer through conversation with the customer during customer service, the person in charge of customer service 49-2 may input the information as person-in-charge information (additional information) from the handy terminal 30. The additional information may include various information pieces, for example, a merchandise category (preferential designation) of merchandise desired by a customer, a color and a shape preferred by the customer, and a use purpose of merchandise. In the present exemplary embodiment, the person in charge of customer service 49-2 inputs, for example, text indicating the additional information to the handy terminal 30 by operating a software keyboard or the like. A form in which the additional information is input is not limited to text, and other forms such as voice, an image, or selection from a menuproduced in advance may be employed.

The person in charge of customer service 49-2 may designate priority for additional information. The priority is information for adjusting the likeliness of extracting merchandise corresponding to additional information (keyword) when merchandise recommended to a customer is extracted. For example, any value may be designated within a predefined range (for example, 0 to 100). For example, the person in charge of customer service 49-2 designates high priority if information obtained through conversation with a customer includes details which are strongly desired by the customer. Consequently, merchandise corresponding to additional information is easily extracted as a target recommended to the customer. The person in charge of customer service 49-2 designates low priority if information obtained through conversation with a customer includes details which are not strongly desired by the customer. If additional information with low priority is input, merchandise which directly corresponds to the additional information is not extracted as a target recommended to the customer. However, as will be described, a plurality of additional information pieces are repeatedly input, and thus merchandise preferred by a customer is easily extracted even if the priority of each piece of additional information is low.

If customer information (additional information) is input through an operation performed by the person in charge of customer service 49-2 (Yes in Act C5, and Act 6), the handy terminal 30 extracts keyword candidates in relation to the additional information (text data) by using a method such as morpheme analysis. The handy terminal 30 displays the keyword candidates, and causes the person in charge of customer service 49-2 to select a keyword which will be transmitted to the content delivery system 21. The person in charge of customer service 49-2 may select all of the keyword candidates and may select any one of the keyword candidates. The person in charge of customer service 49-2 operates the handy terminal 30 so as to input the priority of the keyword selected by the person in charge of customer service 49-2. If the keyword and the priority are input, the handy terminal 30 transmits the keyword and the priority to the content delivery system 21 and also sends a notification of a content extraction request.

If the additional information (the keyword and the priority) are received from the handy terminal 30, the content delivery system 21 reflects the additional information in the customer information 81, the customer attribute clusters 82, and the merchandise clusters 83, so as to extract merchandise (merchandise cluster) (Act C7).

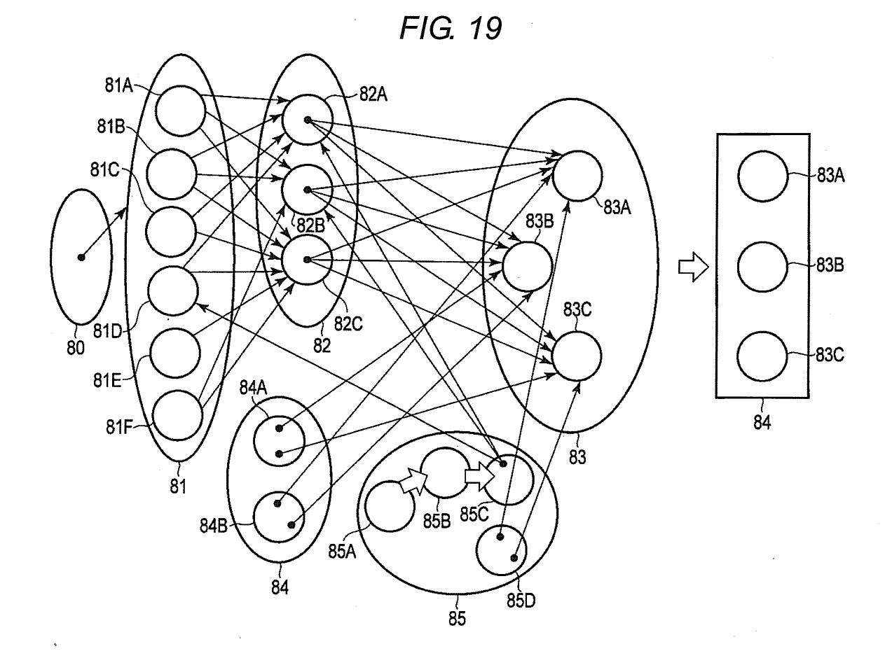

FIG. 19 is a diagram for explaining extraction of content for a customer performed by the content delivery system 21 in the present exemplary embodiment. As illustrated in FIG. 19, the person-in-charge information 85 includes keyword candidates 85B extracted from the additional information (text 85A) input by the person in charge of customer service 49-2, and a keyword 85C selected from the keyword candidates 85B. In the example illustrated in FIG. 19, the keyword 85C is reflected in the customer information 81 and the behavior cluster 82C. If a merchandise category (preferential designation 85D) of merchandise desired by the customer is input as the additional information, the additional information is reflected in a corresponding merchandise cluster of the merchandise clusters 83. In the example illustrated in FIG. 19, according to the preferential designation 85D, the preferential designation 85D is reflected in the merchandise clusters 83A and 83C.

A process of extracting a merchandise cluster corresponding to a customer is performed in the same manner as in the description made with reference to FIG. 12, and a detailed description thereof will be omitted. However, information added as the person-in-charge information 85 is reflected, and thus a merchandise cluster related to the person-in-charge information 85 is easily extracted. For example, the content delivery system 21 weights an attribute corresponding to a keyword included in the customer attribute cluster 82 or merchandise corresponding to a keyword included in the merchandise cluster 83 according to a priority designated by the keyword, and calculates a relational strength between the clusters. Therefore, since a relational strength calculated for information or a cluster related to the person-in-charge information (additional information) increases, a corresponding merchandise cluster is easily extracted.

The content delivery system 21 generates content (merchandise cluster) for merchandise corresponding to the extracted merchandise cluster as customer-based recommendation information (Act C8), and delivers the content to the handy terminal 30 (Act C9). The handy terminal 30 displays the content received from the content delivery system 21 (Act C10). Here, the person in charge of customer service 49-2 confirms the content which is changed as a result of the person-in-charge information being added, and instructs the content to be delivered to the tablet terminal 33 used by the customer. The tablet terminal 33 notifies the content delivery system 21 of a content delivery request in response to the instruction for delivery of the content from the person in charge of customer service 49-2 (Act C11). The content delivery system 21 extracts content for the customer corresponding to the content (merchandise) delivered to the handy terminal 30 in response to the content delivery request from the handy terminal 30 (Act C12), and delivers the content to the tablet terminal 33 (Act C13). The tablet terminal 33 displays the content which is delivered from the content delivery system 21 and in which the person-in-charge information 85 is reflected.

The person in charge of customer service 49-2 may change content to be delivered to the handy terminal 30 and the tablet terminal 33 in the above-described manner by further inputting person-in-charge information (additional information) during business negotiation with the customer. Therefore, information obtained from the customer is repeatedly input, and thus merchandise items preferred by the customer can be narrowed down, and merchandise desired by the customer can be provided. Consequently, the person in charge of customer service 49-2 can more easily perform business negotiation. The customer can easily select desired merchandise from a plurality of merchandise items.

In the above description, an example in which the person in charge of customer service 49-2 inputs the person-in-charge information 85 is described, but other store staff members may input the person-in-charge information 85.

For example, the person in charge of reception 49-1 may input, for example, a visit purpose obtained from a customer coming into the business negotiation room, to the receiving terminal 25. The receiving terminal 25 transmits information regarding the visit purpose to the content delivery system 21 as the person-in-charge information 85. For example, information such as “purchase of merchandise for congratulations on entrance into a school of a child” as the visit purpose may be transmitted to the receiving terminal 25 or the content delivery system 21. The content delivery system 21 adds the information regarding the visit purpose to the customer information 81, and increases a relational strength of corresponding information of the customer attribute cluster 82 or the merchandise cluster 83 on the basis of the information “purchase of merchandise for congratulations on entrance into a school of a child”.

FIG. 19 illustrates, as the customer information 81, not only the registration information 81A and the purchase history 81B but also visit history 81C, a visit purpose 81D, viewing history 81E, and additional person-in-charge information 81F.

A person in charge of content 49-6 may reflect store policy information which is changed at any time, in extraction of a merchandise cluster. The store policy information includes sales strategy merchandise of which the number to be sold is intended to be increased by the store side, member limited merchandise which is prepared for being provided to a member by the store, or the like.

In the example illustrated in FIG. 19, sales strategy merchandise 84A and member limited merchandise 84B are illustrated as the store policy information 84. In this case, the content delivery system 21 calculates a relational strength so that the relational strength between a merchandise cluster corresponding to the sales strategy merchandise 84A and the member limited merchandise 84B and other clusters increases. Consequently, a merchandise cluster corresponding to the store policy information 84 is easily extracted.

In the above-described way, a store staff member adds the information via the staff terminal 14, and content attached with merchandise in which the information is reflected can be provided to a customer. Therefore, information regarding merchandise preferred by the customer can be appropriately provided.

Next, a description will be made of a case where content is changed on the basis of information added by a customer. For example, while a customer stays at the waiting space 44, or the customer is sitting on the table seat 46 or the seat of the table terminal 32, the customer inputs information regarding preferred merchandise during viewing of content delivered from the content delivery system 21, and thus content obtained by narrowing down recommended merchandise items or content of separate merchandise is delivered from the content delivery system 21.

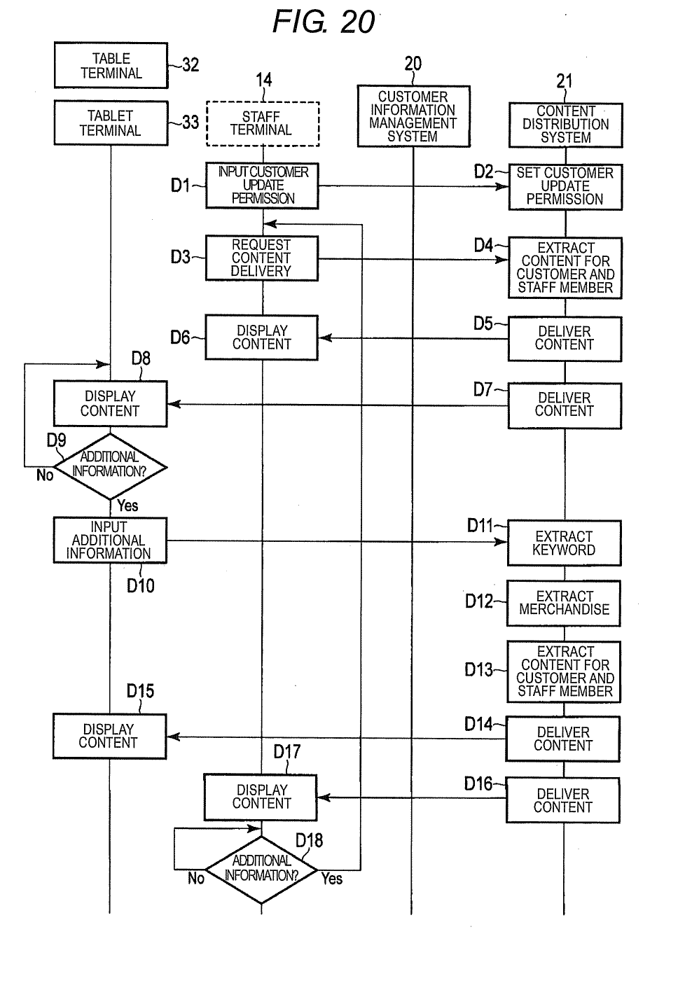

Here, with reference to a flowchart illustrated in FIG. 20, a description will be made of a process for changing content (recommendation information) on the basis of information which is input from the tablet terminal 33 (the table terminal 32).

If content is permitted to be updated by a customer on the basis of additional information, a store staff member (for example, the person in charge of customer service 49-2) inputs an instruction for permitting a customer to be updated from the staff terminal 14 (for example, the handy terminal 30) (Act D1). The handy terminal 30 notifies the content delivery system 21 of the customer update permission. The content delivery system 21 sets the customer update permission in the reception device 16 (for example, the tablet terminal 33) corresponding to the handy terminal 30 which sends the notification of the customer update permission (Act D2).

The handy terminal 30 transmits a content delivery request to the content delivery system 21 in response to an instruction from the person in charge of customer service 49-2 (Act D3). The content delivery system 21 extracts content items for a customer (member) viewing the content and for the store staff member (the person in charge of customer service 49-2) in response to the content delivery request (Act D4). The content delivery system 21 delivers the extracted content for the staff member to the handy terminal 30 (Act D5). The handy terminal 30 displays the content delivered from the content delivery system 21 (Act D6). The content delivery system 21 delivers the content for the customer to the tablet terminal 33 (Act D7). The tablet terminal 33 displays the content delivered from the content delivery system 21. If the content is delivered to the tablet terminal 33 in which the customer update permission is set, the content delivery system 21 allows additional information used to narrow down merchandise items to be input from the tablet terminal 33.

Here, if the customer views the content displayed on the tablet terminal 33 and narrows down desired merchandise items, the customer inputs additional information used to narrow down merchandise items as a customer's additional request from the table terminal 32 (Acts D9 and D10). The tablet terminal 33 transmits the additional information input by the customer to the content delivery system 21 (Act D11). The content delivery system 21 extracts a keyword of the customer's additional request 86 from the additional information (Act D11). The customer may designate a priority of the additional information.

The additional information may employ, for example, text data or an image transmitted from a portable terminal carried by a customer, text data which is input from the tablet terminal 33 by using a software keyboard or which is input through handwriting, an image captured by a camera provided in the tablet terminal 33, voice which is input by a customer via a microphone of the tablet terminal 33, or text data obtained through voice recognition of the input voice. In relation to the text data, keyword candidates are extracted through, for example, morpheme analysis in the same manner as in inputting of the person-in-charge information 85 described above. In relation to the image, a similar image may be searched for from images which are recorded in an image database in advance, and keyword candidates registered in correlation with the similar image may be extracted. Alternatively, a similar image may be searched for via the Internet, and a property (a similar image property) of the similar image may be extracted. The similar image property includes, for example, keyword candidates extracted from text such as a title or a main body related to the similar image.

In the above description, a keyword is extracted from additional information in the content delivery system 21, but a keyword may be extracted from additional information in the tablet terminal 33 and may be transmitted to the content delivery system 21.

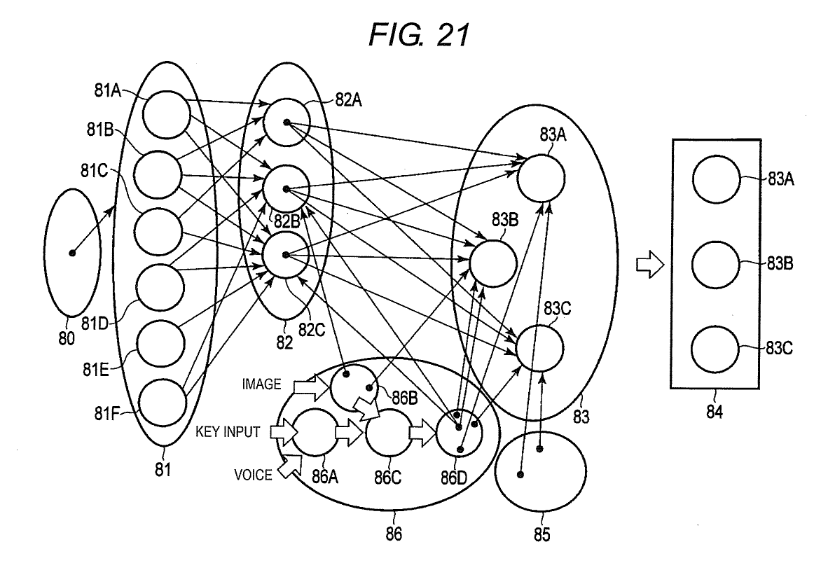

FIG. 21 is a diagram for explaining extraction of content for a customer performed by the content delivery system 21 in the present exemplary embodiment. As illustrated in FIG. 21, the customer's additional request 86 includes keyword candidates 860 extracted from text 86A which is input through key input or voice recognition, and a keyword 86D extracted from the keyword candidates 86C. The keyword candidates 86C include a keyword extracted from a similar image property 86D which is obtained on the basis of an image input by a customer. Reflection of the customer's additional request 86 (keyword) in the customer information 81, the customer attribute cluster 82, and the merchandise cluster 83 is performed in the same manner as in the description made with reference to FIG. 19, and a detailed description thereof will be omitted.

The content delivery system 21 reflects the customer's additional request 86 in the customer information 81, the customer attribute cluster 82, and the merchandise cluster 83 so as to extract merchandise (merchandise cluster) (Act D12). If a priority is designated in the additional information, the content delivery system 21 reflects the priority so as to extract a merchandise cluster. The content delivery system 21 extracts content items for a customer (member) viewing the content item and for the store staff member (the person in charge of customer service 49-2) according to the extracted merchandise cluster (Act D13). The content delivery system 21 delivers the extracted content for the customer to the tablet terminal 33 (Act D14). The tablet terminal 33 displays the content delivered from the content delivery system 21 (Act D15). The content displayed on the tablet terminal 33 is content which is narrowed down to merchandise in which information added by the customer is reflected.

The content delivery system 21 delivers the extracted content for the store staff member to the handy terminal 30 (Act D16). The handy terminal 30 displays the content delivered from the content delivery system 21 (Act D17). The person in charge of customer service 49-2 may view the content displayed on the handy terminal 30, and may add the person-in-charge information 85 in the same manner as described above so as to further narrow down merchandise items recommended to the customer (Act D18).

In the above-described way, the customer service system 10 of the present exemplary embodiment can narrow down merchandise items on the basis of information which is input from the staff terminal 14 used by a store staff member and information which is input from the reception device 16 used by a customer. Content items for the same merchandise may be displayed on the staff terminal 14 and the reception device 16 in synchronization with each other and may respectively have details for a customer and a store staff member. In other words, content which allows merchandise to be easily checked is displayed on the reception device 16, and content including information (supplementary information or the like) effective in customer service is displayed on the staff terminal 14. Therefore, communication between a customer and a store staff member is facilitated via the customer service system 10, and thus merchandise sales promotion can be expected.

In the above description, a case is assumed in which the content providing system (the customer service system 10) of the present exemplary embodiment is used in the business negotiation room for exclusive use of members, but this case is only an example. For example, all of the respective systems 20 to 23, the terminals 25 to 27, and the handy terminals 30, the table terminals 32, and the tablet terminals 33 illustrated in FIG. 1 may not be disposed in the same place such as the business negotiation room. For example, the systems or the terminals may be connected to each other via a network such as the Internet which allows wide area communication to be performed, and thus the content providing system (the customer service system 10) can be configured.

In the above description, a case is assumed in which a single store staff member provides a service to a single customer by using the customer service system 10, but, for example, there may be a case where a plurality of store staff members provide a service to a single customer. For example, two store staff members may individually use the handy terminals 30-1 and 30-2 so as to input new person-in-charge information 85. In this case, content delivered from the content delivery system 21 to the handy terminals 30-1 and 30-2 may be the same content based on merchandise which is extracted as a result of inputting the person-in-charge information 85, and may be content items having different details. Similarly, a plurality of customers may individually use a plurality of table terminals 32 or tablet terminals 33 so as to input new customer's additional requests 86. However, in this case, the content delivery system 21 extracts a merchandise cluster on the basis of customer information of a single person in either case so as to generate content (merchandise catalog). The content delivery system 21 may deliver the same content item or different content items to the table terminals 32 or the tablet terminals 33 used by a plurality of customers.

The content providing system of the present exemplary embodiment can be realized not only as the customer service system 10 but also as other systems for providing information (content) regarding merchandise to a customer or the like.

The invention is not limited to the present exemplary embodiment, and may be embodied by modifying the constituent elements thereof within the scope without departing from the spirit in an implementation stage. Various inventions can be made by combining the plurality of constituent elements disclosed in the present exemplary embodiment with each other as appropriate. For example, some constituent elements may be omitted from all of the constituent elements shown in the present exemplary embodiment. In addition, constituent elements of different exemplary embodiments may be combined as appropriate.

The process disclosed in the present exemplary embodiment may be recorded as a program which can be executed by a computer, on a recording medium such as a magnetic disk (a flexible disk, a hard disk, or the like), an optical disc (a CD-ROM, a DVD, or the like), or a semiconductor memory, and may be provided to various devices. The program may be transmitted by using a communication medium and may be provided to various devices. The computer reads the program recorded on the recording medium or receives the program via the communication medium, and performs the above-described process by the program controlling an operation of the computer.

What is claimed is:

1. A server comprising:
merchandise extraction means for extracting specific merchandise regarding which information is provided to a customer from a plurality of merchandise items on the basis of customer information which is registered in relation to the customer;
first delivery means for delivering first content for the specific merchandise to a first electronic apparatus used by the customer; and
second delivery means for delivering second content for the specific merchandise to a second electronic apparatus used by a store staff member,
wherein the first delivery means delivers the first content corresponding to the changed second content to the first electronic apparatus in response to a request for changing the second content from the second electronic apparatus, and
wherein the second delivery means delivers the second content corresponding to the changed first content to the first electronic apparatus in response to a request for changing the first content from the first electronic apparatus.

2. The server according to claim 1,
wherein the first content and the second content are content items having different details regarding the specified merchandise.

3. The server according to claim 1,
wherein the second content includes information regarding extraction of the specific merchandise performed by the merchandise extraction means.

4. The server according to claim 1,
wherein the second delivery means delivers the second content to a plurality of second electronic apparatuses.

5. A program causing a computer to function as:
merchandise extraction means for extracting specific merchandise regarding which information is provided to a customer from a plurality of merchandise items on the basis of customer information which is registered in relation to the customer;
first delivery means for delivering first content for the specific merchandise to a first electronic apparatus used by the customer; and
second delivery means for delivering second content for the specific merchandise to a second electronic apparatus used by a store staff member,
wherein the first delivery means delivers the first content corresponding to the changed second content to the first electronic apparatus in response to a request for changing the second content from the second electronic apparatus, and
wherein the second delivery means delivers the second content corresponding to the changed first content to the first electronic apparatus in response to a request for changing the first content from the first electronic apparatus.
